(19) United States
(12) Patent Application Publication
(10) Pub. No.: US 2006/0169363 A1
(43) Pub. Date: Aug. 3, 2006

(54) Stable, non-chrome, thin-film organic passivates

(76) Inventors: Jasdeep Sohi, Shelby Township, MI (US); Gregory T. Donaldson, Sterling Heights, MI (US); John D. McGee, Troy, MI (US); Thomas S. Smith II, Novi, MI (US); Brian D. Bammel, Rochester Hills, MI (US)

Correspondence Address: HENKEL CORPORATION, THE TRIAD, SUITE 200, 2200 RENAISSANCE BLVD., GULPH MILLS, PA, 19406, US

(21) Appl. No.: 11/330,869

(22) Filed: Jan. 12, 2006

Related U.S. Application Data
(60) Provisional application No. 60/644,191, filed on Jan. 14, 2005.

(51) Int. Cl. B05D 3/02; B32B 15/04; C23C 22/00; C23C 22/48

(52) U.S. Cl. 148/243; 427/376.1; 428/457; 428/469; 148/247; 148/251

(57) ABSTRACT

Storage-stable organic passivate formulations that are essentially chromium-free are provided comprising non-ionic or non-ionically stabilized organic film forming resin; at least one complex fluoride and optionally, dissolved phosphate anions, at least one component comprising vanadium, at least one inorganic oxide in dispersed form; and at least one wax in dispersed form.

### CROSS-REFERENCE TO RELATED APPLICATION

This application claims priority from U.S. provisional Application Ser. No. 60/644,191, filed 14 Jan. 2005 and incorporated herein by reference in its entirety.

### FIELD OF THE INVENTION

The present invention relates to compositions and processes for passivating, i.e., forming a corrosion resistant surface layer, on metal surfaces preferably predominantly of aluminum and/or zinc. A wide variety of such surfaces are in normal use, including many kinds of galvanized and/or aluminized steel, and the invention is applicable to aluminiferous and/or zinciferous surfaces which differ from the underlying metal, as well as to solid alloys of aluminum and/or zinc.

### BACKGROUND OF THE INVENTION

Zinc (zinciferous) and zinc alloy (such as aluminiferous) coatings are frequently used to protect steel from corrosion. Two common types of metal-coated steel typically used are galvanized steel (zinc) and Galvalume®) (55% Al, 43.5% Zn, 1.5% Si). Both galvanized steel and Galvalume® have long service lifetimes as a result of galvanic and/or sacrificial corrosion protection of the underlying substrate afforded by the coatings. While the underlying steel substrate is protected, the aluminum and zinc coating are sometimes susceptible to corrosion that can result in surface staining and white corrosion.

A variety of treatments can be used to prevent corrosion of ferriferous, zinciferous and aluminiferous surfaces. These include phosphate conversion coating followed by application of an oil, which provides some short term protection, but requires removal of the oil prior to painting. Also, well known in the industry are phosphate conversion coatings, with or without a subsequent painting step. Inorganic passivates, typically using chromium, provide excellent passivation but have the drawbacks of poor paint adhesion and adverse environmental impact. Painting metal substrates passivated with known chromium containing treatments requires aggressive treatments to remove the passivate, which are not industrially practical.

Thin-film organic passivates are used industrially to provide corrosion protection to zinc coated or zinc alloy coated steel. In addition these coatings provide lubricity to facilitate roll forming of steel coils. The thin-film organic passivates are distinguished from typical phosphate conversion coatings by, for example, the presence of organic film forming resin and the amount of protection provided by the coating. Known phosphate conversion coatings generally require an overcoating of paint to achieve adequate corrosion resistance.

Traditionally, most zinciferous and/or aluminiferous surfaces have been passivated by chemical treatment with aqueous liquid compositions containing at least some hexavalent chromium. Thin-film organic passivates generally comprise an organic film forming resin, typically an aqueous dispersion or latex; a surface passivating material, most often a hexavalent chromium containing substance; water and optional additives. The adverse environmental effects of hexavalent chromium that have come to public attention in recent years have resulted in efforts to develop chromium-free compositions useful in passivating metal.

Various attempts have been made to make alternatives to the chromium-containing products by substituting other metals for the chromium in the latex-based passivate treatment products. The alternative products included various metal ions and tend to have a very low pH, that is in the range of pH about 1-2. Many of these attempts failed where the latex became unstable and the formulation coagulated, due at least in part to the low pH and the presence of other ingredients, such as metal ions. Often, even if the formulation did not immediately coagulate, the chromium-free products had little or no shelf life, either separating or coagulating over a matter of days or even hours.

Another drawback of prior art organic passivating compositions is their undesirable effects on the physical attributes of coils of metal. In the coil industry, lengths of sheet metal are typically galvanically coated and passivated in a continuous process. The metal is then coiled for storage and transport, ordinarily while still at elevated temperature. These coils are later unwound as the sheet metal is introduced into a metal forming operation, such as stamping. The metal is cut into selected lengths and formed into component parts of, by way of non-limiting example, appliances, automobiles, furniture. In this industry, the nature of the passivate coating can have undesirable effects of binding or slippage between metal surfaces in the coil. Each undesirable effect causes problems in manufacture; binding refers to the coils sticking together and interferes with uncoiling, and slipping/sliding of the metal surfaces relative to each other in a coil can cause coil collapse. The need to avoid undue lubricity in a passivate coating must also be balanced against the need to provide a formable surface. The passivate coating on the lengths of sheet metal must be sufficiently lubricious, formable and flexible to allow forming of the sheet metal without galling or binding.

As such, there is a need for a composition and process for passivating metal surfaces that overcomes at least one constraint in the prior art.

### SUMMARY OF THE INVENTION

In at least one aspect of the invention, an essentially or substantially chromium-free free composition and process for passivating metal surfaces has been developed that provides corrosion resistance comparable to, i.e. about the same as, previously used chromate-containing passivating agents.

Another aspect of the invention provides a new thin organic coating that reduces the tendency of surfaces of coiled or stacked metal sheet metal that are in contact with each other to stick together, i.e. reduces the tendency of the coil or stack to “bind”.

In another aspect of the invention, thin organic coating is provided that has sufficient lubricity to enhance formability and prevent binding, but not so much that the lubricity contributes to the tendency of coils of metal to collapse due to sliding of metal surfaces, relative to each other within the coil.

The compositions of the invention have been developed as chrome-free passivates that desirably perform as well as, and in some aspects better than, chrome containing passivates of the prior art. Although not preferred, formulations according to the invention can be made including chromium. Compositions according to the invention desirably contain less than 0.04, 0.02, 0.01, 0.001, 0.0001, 0.00001, 0.000001 percent by weight of chromium, most preferably essentially no chromium. It is particularly preferred that the compositions contain less than 0.04, 0.02, 0.01, 0.001, 0.0001, 0.00001, 0.000001 percent by weight of hexavalent chromium, most preferably essentially no hexavalent chromium. The amount of chromium present in the compositions of the invention is desirably minimized and preferably only trace amounts are present, most preferably no chromium is present.

Various embodiments of the invention include working compositions for direct use in treating metals, make-up concentrates from which such working compositions can be prepared by dilution with water, replenisher concentrates suitable for maintaining optimum performance of working compositions according to the invention, processes for treating metals with a composition according to the invention, and extended processes including additional steps that are conventional per se, such as cleaning, rinsing, and subsequent painting or some similar overcoating process that puts into place an organic binder-containing protective coating over the metal surface treated according to one embodiment of the invention. Articles of manufacture including surfaces treated according to a process of the invention are also within the scope of the invention.

In one aspect, the invention provides a composition useful for passivating a metal surface, that includes less than 0.04 wt % chromium, preferably essentially no chromium, most preferably in the absence of chromium, and comprising: water; at least one complex fluoride of an element selected from the group consisting of Ti, Zr, Hf, Si, Sn, Al, Ge and B; preferably Ti and/or Zr; a non-ionic or non-ionically stabilized resin in dispersed form selected from the group consisting of acrylic, polyurethane, vinyl, and polyester resins, and mixtures thereof; and optionally, any one or more of the following: dissolved phosphate anions; at least one component comprising vanadium; at least one inorganic oxide in dispersed form; at least one wax in dispersed form; at least one further additive selected from the group consisting of a sequestrant, a wetting agent, a defoamer, and a pH adjusting component. In a further embodiment of the invention the total concentration of the complex fluoride is at least 0.5 g/L and is not more than 100 g/L.

In a particular embodiment, the composition is essentially free of chromium, c) comprises a non-ionic or non-ionically stabilized acrylic and/or acrylic copolymer resin in dispersed form, said composition comprising at least one pH adjusting component and/or dissolved phosphate anions.

In a different embodiment, the composition is essentially free of chromium, comprises dissolved phosphate anions and c) comprises a non-ionic or non-ionically stabilized resin in dispersed form selected from the group consisting of acrylic resins and polyurethane resins, and mixtures thereof.

In a different embodiment, the composition comprises dissolved phosphate anions and c) comprises a non-ionic or non-ionically stabilized resin in dispersed form selected from the group consisting of acrylic resins and polyurethane resins, and mixtures thereof.

Another aspect of the invention provides a composition having a pH within a range of from about 1 to about 5 and the composition is storage stable at 100 deg. F. for at least 3 months, preferably at least 6 months.

In another embodiment, the composition includes at least one wax, selected from the group of waxes stable in strong acidic solutions having an average particle size less than about 1 micron and a melting point of from about 50 to about 175 degrees C. In a yet further aspect of the invention, the concentration of wax ranges from about 0.05 to about 6 weight percent.

In a second embodiment, the composition includes at least one component that comprises vanadium. In one aspect of the second embodiment, a composition useful for passivating a metal surface is provided comprising less than 0.04 wt % chromium and comprising: water; 0.05-10 weight % of at least one complex fluoride of an element selected from the group consisting of Ti, Zr, Hf, Si, Sn, Al, Ge and B; preferably Ti and/or Zr; a non-ionic or non-ionically stabilized resin in dispersed form, said resin selected from the group consisting of acrylic, polyurethane, vinyl, and polyester resins, and mixtures thereof; 0.1 to 7 weight % of at least one component comprising vanadium; 0.05-20 weight % of at least one wax in dispersed form; and optionally, any one or more of the following: dissolved phosphate anions; at least one inorganic oxide in dispersed form; at least one further additive selected from the group consisting of a sequestrant, a wetting agent, a defoamer, and a pH adjusting component.

In a further aspect of this embodiment, c) comprises 5 -50 weight % of a non-ionic or non-ionically stabilized resin in dispersed form selected from the group consisting of acrylic resins and polyurethane resins, and mixtures thereof.

In a different embodiment of the invention a process of treating a ferriferous, aluminiferous or zinciferous metal substrate is provided comprising: optionally, cleaning a surface of said metal substrate to be passivated; contacting the metal substrate surface to be passivated with a passivating composition as described herein for a time sufficient to form a coating on said metal surface and drying the coating. This process may include the step of coating the metal substrate with a dissimilar metal, thereby creating a metal substrate surface to be passivated, prior to contacting with the passivating composition. Optionally, a process according to the invention may include a step wherein the passivating coating on the metal surface is overcoated with a protective layer comprising at least one organic binder.

Except in the operating examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; specification of materials in ionic form implies the presence of sufficient counter-ions to produce electrical neutrality for the composition as a whole (any counter-ions thus implicitly specified should preferably be selected from among other constituents explicitly specified in ionic form, to the extent possible; otherwise such counter-ions may be freely selected, except for avoiding counter-ions that act adversely to the objects of the invention); the first definition of an acronym or other abbreviation applies to all subsequent uses herein of the same abbreviation and applies mutatis mutandis to normal grammatical variations of the initially defined abbreviation; the term “paint” includes all like materials that may be designated by more specialized terms such as lacquer, enamel, varnish, shellac, topcoat, and the like; and the term “mole” and its variations may be applied to elemental, ionic, and any other chemical species defined by number and type of atoms present, as well as to compounds with well defined molecules.

### DETAILED DESCRIPTION

Reference will now be made in detail to compositions and methods of the invention, which constitute the best modes of practicing the invention presently known to the inventors.

Typically, thin-film organic passivates comprise an organic film forming resin; a surface passivating material; water and optional additives. One of the problems associated with formulations with non-chrome passivating materials in such formulations is the degree to which the non-chrome passivating materials compromise stability in the formulated thin-film passivating composition. Many alternative passivating materials, such as organic and inorganic acids, are most effective when the formulated thin-film passivating composition is at low pH. Under these conditions most resin dispersions or latexes are destabilized, i.e. the resin does not remain dispersed. Two indicators of instability in the composition are phase separation, including precipitation, which is not readily remixed, and coagulation, where the composition may form a consistency similar to, and known in the industry as, “cottage cheese”. Prior art approaches have not provided stable formulations. Such systems either phase separated immediately upon mixing, or separated upon aging at elevated temperature.

It has now been found that using a resin which is non-ionic or non-ionically stabilized provides passivates according to the invention which are stable both immediately after preparation at room temperature, as well as after aging at elevated temperature for several months. Moreover, such compositions can provide corrosion protection to metal surfaces that is at least comparable to that attained using chrome-containing passivates.

Storage-stable organic passivate formulations are obtained when the organic film forming resin is non-ionic or is non-ionically stabilized. The non-ionically stabilized resins of the invention can be stabilized by conventional non-ionic surfactant or by incorporating covalently-bond non-ionic stabilizing groups into the polymer chain of the resin. Compositions according to the invention are stable and do not coagulate upon mixing of the components together. Desirably, the compositions remain dispersed in a single phase, or if phase separation occurs, can be readily remixed. It is preferred that the compositions do not form precipitates or coagulate upon storage for at least, with increasing preference in the order given, 4, 5, 6, 7, 8, 9, 10, 11, 12, 13, 14, 15, 16, 17, 18, 19, 20, 21, 22, 23 or 24 weeks. It is independently preferred that the compositions do not form precipitates or coagulate upon storage at ambient or higher temperatures including, with increasing preference in the order given, 80, 85, 90, 95, 100 and 110 degrees F. Particularly preferred embodiments of the present invention are stable after aging at elevated temperature, e.g. 100 degrees F. for at least six months.

It has been found that one or more of the objects stated above for the invention can be achieved by the use of a passivating aqueous liquid composition, as described herein. The present invention thus provides a composition useful for passivating a metal surface, said composition comprising, preferably consisting essentially of, most preferably consisting of:
a) water;
b) at least one complex fluoride of an element selected from the group consisting of Ti, Zr, * Hf, Si, Sn, Al, Ge and B;

c) a non-ionic or non-ionically stabilized resin in dispersed form said resin selected from the group consisting of acrylic, polyurethane, vinyl, and polyester resins, and mixtures thereof;
d) optionally, dissolved phosphate anions;
e) optionally, at least one component comprising vanadium;
f) optionally, at least one inorganic oxide in dispersed form;
g) optionally, at least one wax in dispersed form; and
h) optionally, at least one further additive selected from the group consisting of a sequestrant, a wetting agent, a defoamer, and a pH adjusting component;
   wherein said composition comprises less than 0.04 wt % chromium, and is preferably essentially free of chromium.

The compositions of the present invention contain, in addition to water, at least one complex fluoride of an element selected from the group consisting of Ti, Zr, Hf, Si, Sn, Al, Ge and B (preferably, Ti, Zr and/or Si; most preferably, Ti). The complex fluoride should be water-soluble or water-dispersible and preferably comprises an anion comprising at least 4 fluorine atoms and at least one atom of an element selected from the group consisting of Ti, Zr, Hf, Si, Sn, Al, Ge or B. The complex fluorides (sometimes referred to by workers in the field as “fluorometallates”) preferably are substances with molecules having the following general empirical formula (I):
HₚT_{q}FᵣOₛ (I)
wherein each of p, q, r, and s represents a non-negative integer; T represents a chemical atomic symbol selected from the group consisting of Ti, Zr, Hf, Si, Sn, Al, Ge, and B; r is at least 4; q is at least 1 and preferably is not more than, with increasing preference in the order given, 3, 2, or 1; unless T represents B, (r+s) is at least 6; s preferably is not more than, with increasing preference in the order given, 2, 1, or 0; and (unless T represents Al) p is preferably not more than (2+s), with all of these preferences being preferred independently of one another. One or more of the H atoms may be replaced by suitable cations such as ammonium, metal, or alkali metal cations (e.g., the complex fluoride may be in the form of a salt, provided such salt is water-soluble or water-dispersible).

The acids are usually preferred for economy and because a net acidity of the compositions is preferable as considered further below, and the entire stoichio-metric equivalent as any. of the above recited fluorometallate ions in any source material as dissolved in a composition according to the invention or a precursor composition for it is to be considered as part of the fluorometallate component, irrespective of the actual degree of ionization that may occur. Independently of their chemical nature, the total concentration of the fluorometallate anions dissolved in a working treatment composition according to the invention preferably is at least, with increasing preference in the order given, 0.5, 1.0, 2.0, 2.5, 3.0, 4.0, 5.0, 6.0, 7.5, 8.5, 10.0, 11.0, 12.0 or 13.0 g/L and independently, primarily for reasons of economy, preferably is not more than, with increasing preference in the order given, 400, 200, 100, 90, 80, 75, 65, 50, 45, 38, 37.5, 35.0, 32.5 30.0, 28.0, 27.0 or 26.0 g/L.

Illustrative examples of suitable complex fluorides include, but are not limited to, H2TiF6 (which is especially preferred), H2ZrF6, H2HfF6, H2SiF6, H2GeF6, H2SnF6, H3AIF6, ZnSiF6, and HBF4 and salts (fully as well as partially neutralized) and mixtures thereof. Examples of suitable complex fluoride salts include SrSiF6, MgSiF6, Na2SiF6 and Li2SiF6.

The dissolved phosphate ions that comprise component (d) may be obtained from a variety of sources as known in the art. Normally much of the phosphate content will be supplied by phosphoric acid added to the composition, and the stoichiometric equivalent as phosphate ions of all undissociated phosphoric acid and all its anionic ionization products in solution, along with the stoichiometric equivalent as phosphate ions of any dihydrogen phosphate, monohydrogen phosphate, or completely neutralized phosphate ions added to the composition in salt form, are to be understood as forming part of phosphate ions, irrespective of the actual degree of ionization and/or reaction to produce some other chemical species that exists in the composition. If any metaphosphoric acid, other condensed phosphoric acids, or salts of any of these acids are present in the compositions, their stoichiometric equivalent as phosphate is also considered part of the phosphate component. Generally, however, it is preferred, at least partly for reasons of economy, to utilize orthophosphoric acid and its salts as the initial source for the phosphate component.

In a working passivating aqueous liquid composition according to this embodiment of the invention, the concentration of phosphate ions and/or their stoichiometric equivalents as noted above preferably is at least, with increasing preference in the order given, 2.0, 3.0, 4.0, 5.0, 6.0, 7.0, 9.0, 10.0, 12.0, 13.0, 14.0, 15.0, 16.0 or 17.0 grams per liter (hereinafter usually abbreviated as “g/L”) of total composition and independently preferably is not more than, with increasing preference in the order given, 400, 200, 100, 90, 80, 75, 70, 60, 50, 45, 40 or 34 g/L.

Furthermore, independently of their actual concentrations, the concentrations of fluorometallate anions (b) and phosphate ions (d) preferably are such that the ratio between them, in working compositions and concentrated solutions used to prepare working concentrations, is at least, with increasing preference in the order given, 0.10:1.0, 0.15:1.0, 0.25:1.0, 0.35:1.0, 0.45:1.0, 0.50:1.0, 0.55:1.0, 0.60:1.0, 0.65:1.0, or 0.75:1.0 and independently preferably is not more than, with increasing preference in the order given, 5:1.0, 4:1.0, 3.5:1.0, 3.2:1.0, 2.0:1.0, 1.5:1.0,1.0:1.0, or 0.9:1.0.

The resin c) used in the present invention may be either non-ionic or non-ionically stabilized. “Non-ionically stabilized”resins include resins that are stabilized (i.e., kept in dispersed form) using a non-ionic surfactant as well as resins that are stabilized by incorporating covalently-bound non-ionic stabilizing groups onto the resin. Preferably, the number of anionic functional groups on the resin is minimized, as this will tend to improve the stability of the dispersed resin under acidic conditions. These resins can be described as aqueous emulsions or dispersions. They can be high molecular weight emulsions such as acrylic latex, polyurethane dispersion, or vinyl latex or they can be low molecular weight dispersions including water reducible polyester, acrylic, or urethane. The resins may be copolymers or mixtures of polymer chains having similar or different functional groups.

These resins can be either thermoplastic or thermosetting . Reactive functionality is any functionality that can react with an external curing agent (two component system) or internal curing agents (one component system). Reactive functionality is acceptable in resins useful in the invention provided that the amount of reactive functionality does not adversely affect the stability of the resulting composition.

The concentration of resin (measured on a solids basis) in the passivate compositions of the invention preferably is at least, with increasing preference in the order given, 4.0, 5.0, 6.0, 7.0, 9.0, 10.0, 12.0, 13.0, 14.0, 15.0, 16.0 or 17.0 weight % (hereinafter usually abbreviated as “g/L”) of total composition and independently preferably is not more than, with increasing preference in the order given, 60, 50, 45, 40, 39, 38, 37, 36, 35, 34, 33, 32, 31, 30, 29; 28, 27, 26, 25, 24, 23, 22, 21 weight %. The optimal amount of resin (c) depends in large part on the desired end property of the coating. If relatively significant corrosion protection is considered more important than ease of coating removability, then a relatively higher amount of resin (c) can be used, however, if ease of coating removability is considered more important than corrosion protection, then a relatively smaller amount of resin (c) can be used.

Furthermore, independently of their actual concentrations, the concentrations of resin (c) and phosphate anions (b) preferably are such that the ratio between them, in working compositions and concentrated solutions used to prepare working concentrations, is at least, with increasing preference in the order given, 0.005:1.0, 0.01:1.0, 0.015:1.0, 0.02:1.0, 0.025:1.0, 0.03:1.0, 0.035:1.0, 0.04:1.0, 0.045:1.0 or 0.05:1.0, and independently preferably is not more than, with increasing preference in the order given, 3.0:1.0, 2.5:1.0, 2.0:1.0, 1.5:1.0, 1.3:1.0, 1.2:1.0, 1.0:1.0, 0.90:1.0, 0.75:1.0, 0.60:1.0, 0.50:1.0, 0.45:1.0, 0.35:1.0, 0.25:1.0, 0.20:1.0, 0.10:1.0 or 0.07:1.0.

Preferred resins include acrylic resins and polyurethane resins. Acrylic resins are well-known in the art and are thermoplastic synthetic organic polymers made by the polymerization of ethylenically unsaturated monomers selected from groups consisting of acrylates, methacrylates, styrene, vinyl, or allylic monomers. Examples of these include monomers such as acrylic acid, methacrylic acid, alkyl esters of acrylates and methacrylates, and the like, including copolymers of such monomers with non-acrylic monomers such as olefins, vinyl compounds, styrene, and the like. Suitable non-ionically stabilized acrylic resin dispersions and latexes are available commercially or may be prepared by known techniques. Suitable acrylic resin based materials include acrylic polymers and acrylic copolymers comprising styrene, acrylates and/or methacrylates. RHOPLEX HA-16 acrylic latex, available from Rohm & Haas, is an example of a commercially available, non-ionically stabilized acrylic resin latex useful in the present invention. RHOPLEX HA-16 is believed to be a high molecular weight copolymer of styrene and acrylates and methacrylates.

Polyurethane resins are also well-known in the art and are resins obtained by reacting polyisocyanates with one or more active hydrogen-containing compounds such as polyether, polyester, polycarbonate, polyacrylic, or polyolefin glycols to form a pre-polymer which can be dispersed in water followed by chain extension with polyamines or polyalcohols. The nonionic stabilization of the acrylic or urethane polymers can be achieved by incorporating a reactive internal non-ionic monomer or by the addition of non-ionic surfactant. Suitable non-ionic polyurethane dispersions and latexes are available commercially or may be synthesized using standard methods. PERMAX 120, 200 and 220 emulsions, available from Noveon, Inc., 9911 Brecksville Road, Cleveland, Ohio 44141-3247, are examples of polyurethane resin dispersions found to be especially useful in the present invention. These materials are described by their supplier as aliphatic polyether waterborne urethane polymers constituting about 35-44% solids.

Generally speaking, the effectiveness of the passivate composition in imparting corrosion resistance to a metal surface will be influenced by the pH of the composition. One or more pH adjusting components may be used in compositions according to the invention. The pH of the treatment formulation should be from 1.0 to 5.0, more preferably 1.2 to 4.5, and most preferably from 1.5 to 3.0. The pH can be adjusted using a pH adjusting component such as an acid such as phosphoric acid, or nitric acid, or a base such as sodium hydroxide, potassium hydroxide, sodium carbonate, or ammonium hydroxide, with ammonium hydroxide being the most preferred. Generally, acids are added to the composition to lower pH and optimize its effectiveness. Although both organic as well as inorganic acids can be used, generally it will be preferred to use a mineral acid such as a phosphorus-containing acid (e.g., phosphoric acid). The phosphate ions included in certain embodiments of the invention may be derived, in whole or in part from this phosphorus-containing acid.

In one embodiment of the invention, the composition comprises at least one component comprising vanadium. When one or more components comprising vanadium are used, independently of their chemical nature, the total concentration of vanadium dissolved in a working composition according to the invention, preferably is at least, with increasing preference in the order given, 0.10, 0.20, 0.25, 0.30, 0.40, 0.50, 0.55, 0.60 or 0.65 weight % of total composition and independently preferably not more than, with increasing preference in the order given, 5.0, 4.0, 3.0, 2.5, 2.0, 1.5, 1.0, 0.90, 0.80 or 0.75 weight %. Preferred sources of vanadium include V₂O₅ and NH₄VO₃.

Additionally, one or more inorganic oxides may be present in the passivate composition, preferably in dispersed, fine particulate form. Oxides of silicon, aluminum, zinc and the like may be used, for example. When one or more components comprising inorganic oxides are used, independently of their chemical nature, the total concentration of inorganic oxides in a working composition according to the invention, preferably is at least, with increasing preference in the order given, 0.10, 0.20, 0.25, 0.30, 0.40, 0.50, 0.55, 0.60 or 0.65 weight % of total composition and independently preferably not more than, with increasing preference in the order given, 5.0, 4.0, 3.0, 2.5, 2.0, 1.5, 1.0, 0.90, 0.80 or 0.75 weight %. LUDOX CL-P silica, available from W. R. Grace & Co., Bonderite NT-1, available from Henkel Corporation, and Nyacol DP 5370, a commercially available aqueous dispersion of nanoparticulate zinc oxide, are illustrative inorganic oxides suitable for use in the present invention.

The composition of the present invention also optionally includes a lubricating agent. The lubricating agent is particularly useful for providing lubrication to surfaces that are to be formed, so as to prevent binding and galling. Lubricating agents that improve lubricity of the coating during forming without increasing water sensitivity of the composition and that are soluble and stable in strong acidic solutions are preferred. Moreover, for use in the coil industry it is desirable that the lubricity provided to the surfaces for subsequent forming does not interfere with stable coiling of the substrate for transport or storage. It is desirable that the lubricating agent is a wax emulsion to aid in dispersal in the composition. Such cares can function as a release aid in the coating formed on the metal surface upon application of the passivate composition, lower the coefficient of friction on the metal surface, improve metal forming, and/or provide anti-block properties. Examples of suitable waxes include Fischer Tropsch waxes, polyethylene waxes (including LDPE and HDPE waxes), paraffin waxes, montan waxes, carnauba wax, ethylene/acrylic acid copolymer waxes, polypropylene waxes, microcrystalline waxes, and the like, and combinations thereof. In one embodiment, polypropylene and paraffin comprise the lubricating agent. Typically, the wax will have an average particle size less than about 1 micron and a melting point of from about 50 to about 175 degrees C.

The concentration of wax in a passivate composition according to the invention preferably is at least, with increasing preference in the order given, 0.5, 1.0, 2.0, 2.5, 3.0, 4.0, 5.0, 6.0, 7.5, 8.5, 10.0, 11.0, 12.0 or 13.0 g/L and independently, primarily for reasons of economy, preferably is not more than, with increasing preference in the order given, 200, 100, 90, 80, 75, 65, 50, 45, 38, 37.5, 35.0, 32.5 30.0, 28.0, 27.0 or 26.0 g/L. I

The passivate composition may also comprise a sequestrant (i.e., sequestering agent). Sequestrants containing two or more phosphonic acid groups per molecule may be used, including, for example, 1-hydroxy ethylidene-1,1-diphosphonic acid (available commercially under the trademark DEQUEST 2010 from Solutia Inc., 575 Maryville Centre Drive, St. Louis, Mo. The sequestrant concentration in the passivate composition may range, for example, from about 0.1 to about 10 weight percent, and preferably is at least, with increasing preference in the order given, 2.0, 3.0, 4.0, 5.0, 6.0, 7.0, 8.0, 9.0, 10.0, 11.0, 12.0 or 13.0, 14.0, 15.0, 16.0, 17.0, 18.0, 19.0, 20, 21, 22, 23, 24, 25, 26, 27, 28, 29, 30 g/L and independently, primarily for reasons of economy, preferably is not more than, with increasing preference in the order given, 90, 80, 75, 65, 64, 63, 62, 61, 60, 59, 58, 57.5, 55.0, 52.5, 50.0 g/L.

The composition of the present invention also optionally includes a wetting agent. The wetting agent is particularly useful for wetting surfaces that are known to be somewhat difficult to wet, such as Galvalume®. Wetting agents that improve coating wetting without increasing water sensitivity of the composition and that are soluble and stable in strong acidic solutions are preferred. Examples of suitable wetting agents include, but are not limited to, phosphate esters and silicon based wetting agents. Byk 348 , a wetting agent commercially available from Byk Chemie, is a silicon surfactant based on the polyether modified poly-dimethyl-siloxane. Preferred phosphate esters include, but are not limited to, substituted phosphate esters, and more preferably substituted carboxylated phosphate esters.

When one or more wetting agents are used, independently of their chemical nature, the total concentration of wetting agent dissolved in a working composition according to the invention, preferably is at least, with increasing preference in the order given, 0.10, 0.20, 0.25, 0.30, 0.40, 0.50, 0.55, 0.60 or 0.65 g/L of total composition and independently preferably not more than, with increasing preference in the order given, 5.0, 4.0, 3.0, 2.5, 2.0, 1.5, 1.0, 0.90, 0.80 or 0.75 g/L.

The passivate composition may also comprise a defoamer, i.e. a defoaming agent. Suitable defoamers are those known defoamers, which do not adversely affect the stability of the composition. In particular, the defoamer desirably is compatible with the resins used. Defoamers containing hydrocarbons and/or non-ionic surfactants may be used, including, for example, Foamaster® NDW (available commercially from Cognis Inc. The defoamer concentration in the passivate composition is not critical provided that sufficient defoaming agent is provided to reduce foaming of the composition, for example, from about 0.01 to about 0.4 weight percent, preferred is 0.02%, depending on the process conditions.

The passivate compositions of the present invention may be used to treat any type of metal surface but are especially useful for passivating the surface of iron-containing metals such as steel, including zinc-coated and zinc alloy-coated steel such as GALVALUME steel as well as hot dipped galvanized steel.

The passivate composition may be applied to the metal surface using any suitable method such as dipping, rolling, spraying, brushing or the like. The composition is kept in contact with the metal surface for a period of time and at a temperature effective to form the desired corrosion protective coating on the surface. Typically, it will be desirable to apply a wet coating of the passivate composition to the metal surface and then to heat the metal surface to a temperature above room temperature to dry the coating.

A process according to the invention in its simplest form consists of bringing a metal surface to be passivated into physical contact with a working composition according to the invention as described above for a period of time, then discontinuing such contact and drying the surface previously contacted. Preferred metal surfaces include galvanized and/or aluminized steel, and solid alloys of aluminum and/or zinc. Physical contact and subsequent separation can be accomplished by any of the methods well known in the metal treatment art, such as immersion for a certain time, then discontinuing immersion and removing adherent liquid by drainage under the influence of natural gravity or with a squeegee or similar device; spraying to establish the contact, then discontinuing the spraying and removing excess liquid as when contact is by immersion; roll coating of the amount of liquid followed by drying into place, and the like. Drying may be accomplished at ambient temperature, but it is preferred that drying take place at elevated temperatures, with the highest metal temperature (peak metal temperature) achieved not exceeding 250 degrees F. to reduce drying time. Typical processes for use of the invention are roll coating, for galvanized metal surfaces it is preferred that passivation be performed immediately after galvanizing. Roll coating is the preferred method of application in the coil industry where the coil can be galvanized and passivated in a continuous process.

Preferably in roll coating processes, the composition is applied to strips of sheet metal from a coil and is then heated to dry and coalesce the coating. The peak metal temperature reached by the substrate during drying is desirably within the range of 150 to 250 degrees F. The quality of the passivation layer formed is not known to be substantially affected by the temperature during passivating if the temperature is within these preferred limits.

Preferably, the thickness of the coating formed by the aqueous liquid composition according to the invention corresponds to at least, with increasing preference in the order given, 100, 150, 200, 250, 300, 350, 400, 450, 500, 550, 600, 650, 700, 750, 800, 850, 900 milligrams per square meter of the metal surface passivated (hereinafter usually abbreviated as “mg/m2”), measured as total weight of the coating, and independently, preferably is not more than, with increasing preference in the order given, 3000, 2500, 2300, 2000, 1800, 1500, 1200, 1000 mg/m2 measured as total weight of the coating. The desired coating weight varies with the application. For instance, for use in appliances and architectural products on, for example Galvalume and HDG, total coating weights of 1.25 g/m2-1.95 g/m2 are preferred; for use in electronic applications on, for example, EG, HDG and Galvaneal, total coating weights of 0.25 g/m2-0.90 g/m2 are preferred.

The amount of total coating weight added-on may conveniently be measured with commercially available instruments, or by other means known to those skilled in the art.

After forming the initial passivating layer as described above, it is sometimes preferred to further improve the corrosion and/or staining resistance of the passivated surface face by overcoating it with a protective layer containing at least an organic binder. It is presently contemplated that any of a wide variety of clear and pigmented paints and like materials, as generally known per se in the art can be used for this purpose. Such an overcoating preferably has a thickness after drying that is at least, with increasing preference in the order given, 0.2, 0.4, 0.6, 0.8, or 1.0 micrometers (hereinafter usually abbreviated as “μm ”) and independently preferably, primarily for reasons of economy, is not more than 10, 7, 5, 3, 2.5, 2.0, 1.5, or 1.3 μm. When the passivated surface is to be used in an application where a metallic appearance is desired, as in roofing for example, this relatively thin clear overcoating can serve adequately as the final coating layer in many instances. For more severe service, additional thicker coatings of paint and like materials adapted to a specific purpose as known per se in the art may be applied directly over this initial thin acrylic overcoating, or directly over the passivated metal surface itself. In other embodiments, the passivated surface is not overcoated, i.e., not painted.

In certain embodiments, the passivating coating can act as a temporary coating. In this temporary coating embodiment, the passivating coating is intended to provide temporary corrosion protection for preventing corrosion and staining during the time period after galvanizing and prior to final finishing, i.e., during storage and shipping. The passivating coating is then removed and the substrate coated with a more permanent corrosion resistant coating, as is known in the art. For instance, the more permanent corrosion resistant coatings can be provided by a suitable conversion coating process. Suitable conversion coating composition and processes are disclosed in U.S. Pat Nos. 4,961,794; 4,838,957; 5,073,196; 4,149,909; 5,356,490; 5,281,282; and 5,769,967, which are hereby incorporated by reference. In this embodiment, if the passivating coating is to be removed, it is presently contemplated that this can be readily done by exposing the passivating coating to a suitable alkaline cleaner solution.

Before passivating according to this invention is to be used for any metal substrate, the substrate to be passivated may, but is not necessarily, thoroughly cleaned by any of various methods well known to those skilled in the art to be suitable for the particular substrate to be coated.

Where galvanized metal surfaces are mentioned in connection with the present invention, they are understood to be material surfaces of electrolytically galvanized or hot-dip-galvanized or even alloy-galvanized steel, preferably electrolytically galvanized or hot-dip-galvanized steel strip. By steel is meant unalloyed to low-alloyed steel of the type used, for example, in the form of sheets for automotive bodywork. The use of galvanized steel, particularly electrolytically galvanized steel in strip form, has grown considerably in significance in recent years. The expression “galvanized steel” in the context of the present invention is understood to encompass electrolytically galvanized steel and also hot-dip-galvanized steel and also applies generally to alloy-galvanized steel, zinc/nickel alloys, zinc/iron alloys (Galvanealed) an zinc/aluminum alloys (GALFAN®, from Eastern Alloys, Inc., of Maybrook, N.Y. GALVALUME ™, from BIEC International, Inc. of Vancouver, Wash. ) playing a particularly crucial role as zinc alloys.

The practice of this invention may be further appreciated by consideration of the following, non-limiting examples, and the benefits of the invention may be appreciated by the examples set forth below.

### EXAMPLES

### EXAMPLES 1-5

Applicants prepared a series of latexes to assess stability under low pH conditions, which are found in non-chrome thin-film organic passivates.

Example 1 was a cationic latex stabilized by addition of a non-ionic surfactant. This nonionically stabilized cationic latex was prepared according to the following procedure:

TABLE 1

| Part | Ingredient | Grams |
|---|---|---|
| A) | DI water | 293.5 |
| | Triton X-305 | 7.4 |
| B) | DI water | 39.6 |
| | Triton X-305 | 9.1 |
| | butyl methacrylate | 40.4 |
| | methyl methacrylate | 39.8 |
| | Styrene | 13.5 |
| | 2-ethylhexyl acrylate | 37.1 |
| | Hexanediol diacrylate | 1.2 |
| C) | DI water | 102.9 |
| | Triton X-305 | 23.7 |
| | butyl methacrylate | 105.1 |
| | Hexanediol diacrylate | 1.2 |
| | 2-ethylhexyl acrylate | 97.5 |
| | Styrene | 35.0 |
| | methyl methacrylate | 104.5 |
| | Dimethylaminoethyl methacrylate | 9.7 |
| D1) | 70% t-butyl hydroperoxide | 0.22 |
| | DI water | 2.50 |
| D2) | 1% Ferrous sulfate | 0.50 |
| D3) | Sodium formaldehyde sulfoxylate | 0.15 |
| | DI water | 2.50 |
| D4) | 1% EDTA sodium salt | 3.1 |
| E) | 70% t-butyl hydroperoxide | 2.75 |
| | DI water | 65 |
| F) | Sodium formaldehyde sulfoxylate | 0.65 |
| | DI water | 65 |
| G) | DI water | 22.4 |
| | Total | 1126.0 |

To 2 liter four-necked flask, equipped with stirrer, condenser, and nitrogen inlet was added part (A). Stirring and Nitrogen blanket were applied. Parts (B) and (C) were added to and mixed by shaking in separate containers until uniform stable dispersions were obtained. (E) and (F) were added to separate beakers and stirred to form clear solutions. The flask was heated to 40 degrees C. at which time (B) was added followed immediately by addition of (D1) through (D4). The flask contents exothermed to a temperature of 75 C. over 30 minutes after which time (C), (E) and (F) were added at a uniform rate over 2 hours. During the two-hour addition, temperature was maintained at 65 degrees C. After additions were complete, (G) was used to rinse (C) residues into the flask. Temperature was maintained at 65 degrees C for a period of 20 minutes at which time the polymerization was complete. The flask contents were cooled and filtered. Final particle size was 173 nm and measured solids were 44.8%.

Example 2 was a cationic latex similar to Example 1, but the amine monomer was not used. This nonionically stabilized cationic latex was prepared according to the following procedure and stabilized by an non-ionic surfactant:

TABLE 2

| Part | Ingredient | Grams |
|---|---|---|
| A) | DI water | 293.5 |
| | Triton X-305 | 7.4 |
| B) | DI water | 142.5 |
| | Triton X-305 | 32.9 |
| | butyl methacrylate | 155.2 |
| | methyl methacrylate | 144.3 |
| | Styrene | 48.5 |
| | 2-ethylhexyl acrylate | 75.0 |
| | Butyl acrylate | 59.6 |
| | Hexanediol diacrylate | 2.4 |
| C1) | 70% t-butyl hydroperoxide | 0.22 |
| | DI water | 2.50 |
| C2) | 1% Ferrous sulfate | 0.50 |
| C3) | Sodium formaldehyde sulfoxylate | 0.15 |
| | DI water | 2.50 |
| C4) | 1% EDTA sodium salt | 3.1 |
| D) | 70% t-butyl hydroperoxide | 2.75 |
| | DI water | 65 |
| E) | Sodium formaldehyde sulfoxylate | 0.65 |
| | DI water | 65 |
| F) | DI water | 22.4 |
| | | 1126.0 |

To a 2 liter four-necked flask, equipped with stirrer, condenser, and nitrogen inlet was added part (A). Stirring and Nitrogen blanket were applied. Part (B) was added to and mixed by shaking in a container until a uniform stable dispersion was obtained. (D) and (E) were added to separate beakers and stirred to form clear solutions. The flask was heated to 40 degrees C. at which time 180.7g of (B) was added followed immediately by addition of (C1) through (C4). The flask contents exothermed to a temperature of 75 degrees C. over 30 minutes after which time the remainder of (B), (D) and (E) were added at a uniform rate over 2 hours. During the two hour addition, temperature was maintained at 65 degrees C. After additions were complete, (F) was used to rinse (B) residues into the flask. Temperature was maintained at 65 degrees C. for a period of 20 minutes at which time the polymerization was complete. The flask contents were cooled and filtered. Final particle size was 148 nm and measured solids were 45.6%.

Example 3 and 4 were cationic latexes stabilized by the incorporation of a polymerizable non-ionic surfactant into the polymer chain and were prepared as follows:

TABLE 3

| Part | Ingredient | Grams |
|---|---|---|
| A) | DI water | 146.8 |
| | Noigen RN-20 | 2.6 |
| B) | DI water | 71.3 |
| | Noigen RN-20 | 11.5 |
| | butyl methacrylate | 77.6 |
| | methyl methacrylate | 72.2 |
| | Styrene | 24.3 |
| | 2-ethylhexyl acrylate | 67.3 |
| | Hexanediol diacrylate | 1.2 |
| C1) | 70% t-butyl hydroperoxide | 0.11 |
| | DI water | 1.3 |
| C2) | 1% Ferrous sulfate | 0.25 |
| C3) | Sodium formaldehyde sulfoxylate | 0.08 |
| | DI water | 1.3 |
| C4) | 1% EDTA sodium salt | 1.6 |
| D) | 70% t-butyl hydroperoxide | 1.4 |
| | DI water | 33 |
| E) | Sodium formaldehyde sulfoxylate | 0.33 |
| | DI water | 33 |
| F) | DI water | 11.2 |
| | | 558.4 |

To a 2 liter four-necked flask, equipped with stirrer, condenser, and nitrogen inlet was added part (A). Stirring and Nitrogen blanket were applied. Part (B) was added to and mixed by shaking in a container until a uniform stable dispersion was obtained. (D) and (E) were added to separate beakers and stirred to form clear solutions. The flask was heated to 40 degrees C. at which time 90.3 g of (B) was added followed immediately by addition of (C1) through (C4). The flask contents was heated to a temperature of 65 C over 30 minutes after which time the remainder of (B), (D) and (E) were added at a uniform rate over 2 hours. During the two hour addition, temperature was maintained at 65 degrees C. After additions were complete, (F) was used to rinse (B) residues into the flask. Temperature was maintained at 65 degrees C. for a period of 20 minutes at which time the polymerization was complete. The flask contents were cooled and filtered. Final particle size was 268nm and measured solids were 45.5%.

Example 4 is an additional non-ionically stabilized latex prepared using the formulation and procedure described by example 3. Final particle size was 217nm and measured solids were 45.1%.

Example 5 is a Comparative Example using a cationic latex typical of those used in the coil industry stabilized by use of a polymerizable anionic surfactant. This cationic latex was prepared according to the following procedure., and was stabilized by the incorporation of the anionic stabilizing groups into the polymer chain of the resin:

TABLE 4

| Part | Ingredient | Grams |
|---|---|---|
| A) | DI water | 293.6 |
| B) | butyl methacrylate | 64.0 |
| | methyl methacrylate | 59.5 |
| | Styrene | 20.0 |
| | butyl acrylate | 55.5 |
| | Hexanediol diacrylate | 1.0 |
| | Hitenol BC-10 | 6.0 |
| C) | Ammonium persulfate | 0.4 |
| | DI water | 5.0 |
| D) | DI water | 105 |
| | Total | 610.0 |

To a 2 liter four-necked flask, equipped with stirrer, condenser, and nitrogen inlet was added part (A). Stirring and Nitrogen blanket were applied. Part (B) was added to and mixed by stirring in a separate container. (C) was added to a beaker and stirred to form clear solution. The flask was heated to 80 degrees C. after which time 41.2 g of (B) was added followed by addition of (C). The flask contents were maintained at a temperature of 80 C while the remainder of (B) was added over 3 hours. After additions were complete, (D) was added to the flask. Temperature was maintained at 80 degrees C. for a period of 30 minutes at which time the polymerization was complete. The flask contents were cooled and filtered. Final particle size was 95nm and measured solids were 33.4%.

Triton X-305 is a nonionic surfactant from Dow Chemical. EDTA is ethylenediaminetetraacetic acid. Noigen RN-20 is a polymerizable nonionic surfactant from DKS International, Inc. Hitenol BC-10 is a polymerizable anionic surfactant from DKS International, Inc. EXAMPLES 6-18

Commercially available resins, as well as those of Examples 1-5, were utilized to make non-chrome, thin-film organic passivate compositions, according to Tables 5 and 6, below. In Examples 6-12, the ratio of Part A to Part B was 1:1 parts by volume. When the resin of Example 5 was mixed with the other constituents, the composition gelled and no further testing of Example 5 was done.

TABLE 5

| | | COMPONENT A | | | | | | | | | | | |
|---|---|---|---|---|---|---|---|---|---|---|---|---|---|
| | | (grams) | | | COMPONENT B (grams) | | | | | | | | |
| | % | H₂O | H₃PO₄ | H₂TiF₆ | H₂O | Dequest | HA | | | Ex | Ex | Ex | Ex |
| EX | Solids | DI | 75% | 50% | DI | 2010 | 16 | Lube | APP* | 1 | 2 | 3 | 4 |
| 6 | 15.86 | 89.5 | 7 | 3.5 | 46.2 | 12 | 35.3 | 6.5 | | | | | |
| 7 | 16.36 | 89.5 | 7 | 3.5 | 36.2 | 12 | 35.3 | 6.5 | 10 | | | | |
| 8 | 24.79 | 89.5 | 7 | 3.5 | 6.5 | 12 | 75 | 6.5 | | | | | |
| 9 | 24.72 | 89.5 | 7 | 3.5 | 6.5 | 12 | | 6.5 | | 75 | | | |
| 10 | 24.79 | 89.5 | 7 | 3.5 | 6.5 | 12 | | 6.5 | | | 75 | | |
| 11 | 24.98 | 89.5 | 7 | 3.5 | 6.5 | 12 | | 6.5 | | | | 75 | |
| 12 | 24.81 | 89.5 | 7 | 3.5 | 6.5 | 12 | | 6.5 | | | | | 75 |

*Amino-phenolic polymer

Non-chrome, thin-film organic passivate compositions were made as two pack compositions by first formulating Component A and Component B as found in Table 5, and then combining the two components. The passivate compositions were also formulated as one pack compositions, as found in Table 6, below, by combining all constituents of the composition in a single batch mix, rather than formulating separate components.

TABLE 6

| | | | | Bon- | De- | | | | |
|---|---|---|---|---|---|---|---|---|---|
| | H₂O | H₃PO₄ | H₂TiF₆ | derite | quest | | Ex | Ex | HA |
| EX | DI | 75% | 50% | NT-1 | 2010 | Lube | 1 | 2 | 16 |
| 13 | 44.75 | 3.5 | 1.75 | | 6 | 6.5 | 37.5 | | |
| 14 | 45.45 | 3.5 | 1.75 | | 6 | 6.5 | | 36.8 | |
| 15 | 45.45 | 3.5 | 1.75 | | 6 | 6.5 | | | 36.8 |
| 16 | 38.75 | 3.5 | 1.75 | 6 | 6 | 6.5 | 37.5 | | |
| 17 | 39.45 | 3.5 | 1.75 | 6 | 6 | 6.5 | | 36.8 | |
| 18 | 39.45 | 3.5 | 1.75 | 6 | 6 | 6.5 | | | 36.8 |

Amounts are in grams

The pH of Examples 6-18 was 2.6. Bonderite NT-1 is a phosphate free surface treatment containing inorganic oxide particles and dissolved fluorometallate anions commercially available from Henkel Corporation. Dequest 2010 is an aqueous solution of phosphonic acids comprising approximately 60 wt % 1-hydroxyethylidene-1, 1-diphosphonic acid commercially available from Solutia, Inc. The lubricant used for Examples 6-18 was ML160, a waterborne wax emulsion commercially available from Michelman, Inc.; it is described in product literature as a low VOC, anionic carnauba wax having a particle size of 0.135 microns, a melting point of 85 ° C. and an ASTM D-5 hardness of 1. HA16 in Tables 5 and 6 is Rhoplex HA-16 commercially available from Rohm & Haas; it is described in product literature as a nonionic, self cross-linking acrylic emulsion polymer having a pH of 2.6 and a solids wt % of 45.5.

Variations of the compositions of Examples 13-18 were also prepared. For Examples 13C, 14C and 15B, the formulations in Table 6 were made according to Examples 13, 14 and 15, respectively, with the exception that additional distilled water was used in place of the Dequest 2010 to achieve 100 grams total weight. The remaining variations of Examples 13-18 were made according to their respective Examples 13-18, and additional components were introduced, as recited in the Additives column of Table 7. The pH of Examples 6-18 was 2.6, including the variations was 2.6.

The compositions were tested for phase stability, based on phase separation or coagulation after mixing that was visible to the unaided human eye, and storage stability, which was assessed by aging the composition at 100° F. for 6 months and observing whether phase separation or coagulation, visible to the unaided human eye, had taken place.

TABLE 7
Stability Testing

| | | | | Storage |
|---|---|---|---|---|
| | | | | Stability |
| Formulation | Resin | Additives | Phase Stability | @ 100° F. |
| Example 6 | Rhoplex HA16 | | pass | fail |
| Example 7 | Rhoplex HA16 | | pass | fail |
| Example 8 | Rhoplex HA16 | | pass | fail |
| Example 9 | Example 1 | | pass | Pass |
| Example 10 | Example 2 | | pass | Pass |
| Example 11 | Example 3 | | pass | Pass |
| Example 12 | Example 4 | | pass | Pass |
| Example 13A | Example 1 | | pass | Pass |
| Example 13B | Example 1 | 0.02% Byk 348 | pass | Pass |
| Example 13C | Example 1 | w/o Dequest 2010 | pass | Pass |
| Example 13D | Example 1 | 1% Nyacol DP 5370 | pass | Pass |
| Example 14A | Example 2 | | pass | Pass |
| Example 14B | Example 2 | 0.02% Byk 348 | pass | Pass |
| Example 14C | Example 2 | w/o Dequest 2010 | pass | Pass |
| Example 14D | Example 2 | 1% Nyacol DP 5370 | pass | Pass |
| Example 15A | RHOPLEX HA 16 | | pass | fail |
| Example 15B | RHOPLEX HA 16 | w/o Dequest 2010 | pass | fail |
| Example 16A | Example 1 | | pass | Pass |
| Example 16B | Example 1 | 1% Nyacol DP 5370 | pass | Pass |
| Example 17A | Example 2 | | pass | Pass |
| Example 17B | Example 2 | 1% Nyacol DP 5370 | pass | Pass |
| Example 18A | RHOPLEX HA 16 | | fail | Fail |
| Example 18B | RHOPLEX HA 16 | 1% Nyacol DP 5370 | fail | Fail |

Byk 348 is a wetting agent, commercially available from Byk Chemie. Byk 348 is a silicon surfactant, based on the polyether modified poly-dimethyl-siloxane. Nyacol DP 5370 is a commercially available aqueous dispersion of nanoparticulate zinc oxide.

### EXAMPLES 19-28

Non-chrome, thin-film organic passivate compositions containing vanadium were formulated according to Table 8, below.

TABLE 8
Non-chrome thin film passivate formulations containing Vanadium

| pbw | Ex. 19 | Ex. 20 | Ex. 21 | Ex. 22 | Ex. 23 | Ex. 24 | Ex. 25 | Ex. 26 | Ex. 27 | Ex. 28 |
|---|---|---|---|---|---|---|---|---|---|---|
| DI Water | 36.6 | 36.3 | 42.25 | 40.95 | 40.95 | 43.35 | 39.65 | 57.15 | 59.75 | 57.15 |
| V2O5 | 1 | | 1 | 1 | 1 | 1 | 1 | | | |
| NH4VO3 | | 1.3 | | | | | | 1.3 | 1.3 | 1.3 |
| 50% NaOH | 2.3 | 2.3 | 2.3 | | | | 2.3 | 2.3 | 2.3 | 2.3 |
| 45% KOH | | | | 3.6 | | | | | | |
| 28% | | | | | 3.6 | | | | | |
| NH4OH | | | | | | | | | | |
| LiOH.H2O | | | | | | 1.2 | | | | |
| Dequest | 6 | 6 | 6 | 6 | 6 | 6 | 6 | 6 | 6 | 6 |
| 2010 | | | | | | | | | | |
| 75% H3PO4 | 5.4 | 5.4 | 5.4 | 5.4 | 5.4 | 5.4 | 7 | 7 | 5.4 | 7 |
| 50% H2TiF6 | 1.75 | 1.75 | 1.75 | 1.75 | 1.75 | 1.75 | 1.75 | 1.75 | 1.75 | 1.75 |
| Nyacol | | | | | | | | | | 1 |
| BP 5370 | | | | | | | | | | |
| Zinc Oxide | | | | | | | 1 | 1 | | |
| Permax 220 | 23.6 | 23.6 | | | | | | | | |
| Permax 200 | 18.75 | 18.75 | | | | | | | | |
| Resin 1 | | | 17.5 | 17.5 | 17.5 | 17.5 | 17.5 | 17 | 17 | 17 |
| Resin 2 | | | 17.3 | 17.3 | 17.3 | 17.3 | 17.3 | | | |
| Lube | 6.5 | 6.5 | 6.5 | 6.5 | 6.5 | 6.5 | 6.5 | 6.5 | 6.5 | 6.5 |

Permax 220 and 200 are nonionically stabilized urethane resins available from Noveon Inc. and described as aliphatic polyether waterborne urethane polymers constituting about 35-44% solids Resin 1 and 2 are nonionically stabilized acrylic resins with a solids content of approximately 45-50%. The lubricant used for Examples 19-28 was ML160, a waterborne wax emulsion commercially available from Michelman, Inc.

Galvalume and Hot Dip Galvanized (HDP) steel panels were obtained from the National Steel, Trenton, Mich. The panels were coated with the compositions as recited in Table 8 using a # 3 drawbar and also with a laboratory scale roll coater designed to approximate industrial roll coating conditions. All panels were dried in an oven and reached a peak metal temperature (PMT) of 200 Deg F.

TABLE 9
Corrosion results

| | Ex. 19 | Ex. 20 | Ex. 21 | Ex. 22 | Ex. 23 | Ex. 24 | Ex. 25 | Ex. 26 |
|---|---|---|---|---|---|---|---|---|
| | % | % | % | % | % | % | % | % |
| | Corrosion/ | Corrosion/ | Corrosion/ | Corrosion/ | Corrosion/ | Corrosion/ | Corrosion/ | Corrosion/ |
| | Hrs | Hrs | Hrs | Hrs | Hrs | Hrs | Hrs | Hrs |
| Neutral Salt | 5-648 | 5-936 | 5-1008 | 1-1008 | 2-1008 | 2-1008 | 3-1008 | 2-600 |
| Spray on | | | | | | | | |
| Galvalume | | | | | | | | |
| Neutral Salt | 7-312 | 7-432 | 5-420 | 3-168 | 10-336 | 10-168 | 10-336 | 3-264 |
| Spray on | | | | | | | | |
| HDG | | | | | | | | |
| Stack Test | 10-168 | 30-168 | 5-1008 | 10-1008 | 3-1008 | 10-840 | 10-840 | 3-1008 |
| on | | | | | | | | |
| Galvalume | | | | | | | | |
| Stack test | 7-336 | 10-168 | 10-504 | 10-504 | 3-504 | 7-504 | 7-336 | 10-672 |
| on Hot | | | | | | | | |
| Dipped | | | | | | | | |
| Galvanized | | | | | | | | |
| Butler | 10-2016 | 10-1848 | 3-2016 | 5-1008 | 10-672 | 3-1008 | 0-1008 | 0-1008 |
| Water | | | | | | | | |
| Immersion | | | | | | | | |
| test on | | | | | | | | |
| Galvalume | | | | | | | | |
| Butler | 3-168 | 7-168 | 5-504 | 3-336 | 10-1008 | 10-1008 | 7-336 | 7-336 |
| Water | | | | | | | | |
| Immersion | | | | | | | | |
| test on | | | | | | | | |
| HDG | | | | | | | | |
| Cleveland | 10-672 | 100-360 | 7-1008 | 3-1008 | 3-1008 | 3-1008 | 3-672 | 3-672 |
| Condensing | | | | | | | | |
| on | | | | | | | | |
| Galvalume | | | | | | | | |
| Cleveland | 10-672 | 40-360 | 7-1008 | 10-1008 | 10-1008 | 3-1008 | 10-672 | 5-672 |
| Condensing | | | | | | | | |
| on Hot | | | | | | | | |
| Dipped | | | | | | | | |
| Galvanized | | | | | | | | |

Although the invention has been described with particular reference to specific examples, it is understood that modifications are contemplated. Variations and additional embodiments of the invention described herein will be apparent to those skilled in the art without departing from the scope of the invention as defined in the claims to follow. The scope of the invention is limited only by the breadth of the appended claims.

1. A composition useful for passivating a metal surface, said composition comprising:
a) water;
b) at least one complex fluoride of an element selected from the group consisting of Ti, Zr, Hf, Si, Sn, Al, Ge and B;
c) a non-ionic or non-ionically stabilized resin in dispersed form said resin selected from the group consisting of acrylic, polyurethane, vinyl, and polyester resins, and mixtures thereof;
d) optionally, dissolved phosphate anions;
e) optionally, at least one component comprising vanadium;
f) optionally, at least one inorganic oxide in dispersed form;
g) optionally, at least one wax in dispersed form; and
h) optionally, at least one further additive selected from the group consisting of a sequestrant, a wetting agent, a defoamer, and a pH adjusting component;
wherein said composition comprises less than 0.04 wt % chromium.

2. The composition of claim 1, wherein the total concentration of the complex fluoride is at least 0.5 g/L and is not more than 100 g/L.

3. The composition of claim 1, wherein the at least one complex fluoride is a titanium and/or zirconium complex fluoride.

4. The composition of claim 1, wherein said composition is essentially free of chromium, c) comprises a non-ionic or non-ionically stabilized acrylic and/or acrylic copolymer resin in dispersed form, said composition comprising at least one pH adjusting component.

5. The composition of claim 1, wherein the composition is essentially free of chromium, comprises dissolved phosphate anions and c) comprises a non-ionic or non-ionically stabilized resin in dispersed form selected from the group consisting of acrylic resins and polyurethane resins, and mixtures thereof.

6. The composition of claim 1, wherein the pH of the composition is within a range of from about 1 to about 5 and the composition is storage stable at 100 deg. F. for at least 3 months.

7. The composition of claim 1, wherein the composition comprises dissolved phosphate anions and c) comprises a non-ionic or non-ionically stabilized resin in dispersed form selected from the group consisting of acrylic resins and polyurethane resins, and mixtures thereof.

8. The composition of claim 1, comprising at least one component that comprises vanadium.

9. The composition of claim 1, comprising at least one wax, selected from the group of waxes stable in strong acidic solutions having an average particle size less than about 1 micron and a melting point of from about 50 to about 175 degrees C.

10. The composition of claim 1, wherein the concentration of wax ranges from about 0.05 to about 6 weight percent.

11. A composition useful for passivating a metal surface, said composition comprising:
a) water;
b) 0.05-5 weight % of at least one complex fluoride of an element selected from the group consisting of Ti, Zr, Hf, Si, Sn, Al, Ge and B;
c) a non-ionic or non-ionically stabilized resin in dispersed form, said resin selected from the group consisting of acrylic, polyurethane, vinyl, and polyester resins, and mixtures thereof;
d) optionally, dissolved phosphate anions;
e) 0.1 to 7 weight % of at least one component comprising vanadium;
f) optionally, at least one inorganic oxide in dispersed form;
g) 0.05-20 weight % of at least one wax in dispersed form;
h) optionally, at least one further additive selected from the group consisting of a sequestrant, a wetting agent, a defoamer, and a pH adjusting component;
said composition comprising less than 0.04 wt % chromium.

12. The composition of claim 11 wherein c) comprises 10 -50 weight % of a non-ionic or non-ionically ionically stabilized resin in dispersed form selected from the group consisting of acrylic resins and polyurethane resins, and mixtures thereof.

13. The composition of claim 11, wherein the pH of the composition is within a range of from about 1 to about 5 and the composition is storage stable at 100 deg. F. for at least 3 months.

14. A process of treating a ferriferous, aluminiferous or zinciferous metal substrate comprising:
optionally, cleaning a surface of said metal substrate to be passivated;
contacting the metal substrate surface to be passivated with a passivating composition for a time sufficient to form a coating on said metal surface, wherein the passivating composition comprises:
a) water;
b) at least one complex fluoride of an element selected from the group consisting of Ti, Zr, Hf, Si, Sn, Al, Ge and B;
c) a non-ionic or non-ionically stabilized resin in dispersed form said resin selected from the group consisting of acrylic, polyurethane, vinyl, and polyester resins, and mixtures thereof;
d) optionally, dissolved phosphate anions;
e) optionally, at least one component comprising vanadium;
f) optionally, at least one inorganic oxide in dispersed form;
g) optionally, at least one wax in dispersed form; and
h) optionally, at least one further additive selected from the group consisting of a sequestrant, a wetting agent, a defoamer, and a pH adjusting component;
said composition comprising less than 0.04 wt % chromium; and
drying said coating on the metal surface.

15. The process of claim 14 wherein the metal substrate temperature during drying ranges between ambient temperature and 250 degrees F.

16. The process of claim 14 further comprising the step of coating the metal substrate with a dissimilar metal, thereby creating a metal substrate surface to be passivated, prior to contacting with the passivating composition.

17. The process of claim 14 wherein the coated metal surface is overcoated with a protective layer comprising at least one organic binder.

18. The process of claim 14 wherein said composition is essentially free of chromium, comprises dissolved phosphate anions and c) comprises a non-ionic or non-ionically stabilized resin in dispersed form selected from the group consisting of acrylic resins and polyurethane resins, and mixtures thereof.

19. An article of manufacture comprising:
a metal substrate selected from the group consisting of ferriferous, aluminiferous and zinciferous metals, said ferriferous metal substrate comprising a surface layer of a dissimilar metal selected from the group consisting of aluminiferous and zinciferous metals; and
a passivating coating on at least one surface of said metal substrate, said coating comprising the reaction product of said at least one surface and a composition comprising:
a) water;
b) at least one complex fluoride of an element selected from the group consisting of Ti, Zr, Hf, Si, Sn, Al, Ge and B;
c) a non-ionic or non-ionically stabilized resin in dispersed form said resin selected from the group consisting of acrylic, polyurethane, vinyl, and polyester resins, and mixtures thereof;
d) optionally, dissolved phosphate anions;
e) optionally, at least one component comprising vanadium;
f) optionally, at least one inorganic oxide in dispersed form;
g) optionally, at least one wax in dispersed form; and
h) optionally, at least one further additive selected from the group consisting of a sequestrant, a wetting agent, a defoamer, and a pH adjusting component;
said composition comprising less than 0.04 wt % chromium.

20. The article of claim 19 wherein the passivating coating on the metal surface is overcoated with a protective layer comprising at least one organic binder.

21. The process of claim 19 wherein the composition is essentially free of chromium, comprises dissolved phosphate anions and c) comprises a non-ionic or non-ionically stabilized resin in dispersed form selected from the group consisting of acrylic resins and polyurethane resins, and mixtures thereof.
